(19) United States
(12) Patent Application Publication
(10) Pub. No.: US 2025/0053514 A1
(43) Pub. Date: Feb. 13, 2025

(54) DIRECTORY-LESS SNOOP OFFLOAD OF A HIGHER LEVEL CACHE MANAGEMENT AGENT WITH SNOOP FENCE

(71) Applicant: International Business Machines Corporation, Armonk, NY (US)

(72) Inventor: Scot RIDER, Pleasant Valley, NY (US)

(21) Appl. No.: 18/366,943

(22) Filed: Aug. 8, 2023

(51) Int. Cl. G06F 12/0831; G06F 12/0811

(52) U.S. Cl. CPC G06F 12/0831; G06F 12/0811

(57) ABSTRACT

Techniques and apparatus for maintaining cache coherency in a data processing system are described. An example technique includes receiving a fetch request from a processor of a plurality of processors in a cluster. A local snoop operation is performed for the cluster in response to the fetch request and without involving an upper level cache associated with the cluster. A fetch response is sent to the processor based on the local snoop operation. Another technique includes receiving a fetch request from a processor of a plurality of processors in a cluster. A snoop request is sent to trigger a local snoop operation for the cluster, in response to the fetch request. A snoop response including an indication that at least one processor in the cluster is in an offline state is received in response to the snoop request.

### BACKGROUND

The present disclosure relates to data processing systems, and more specifically, systems and techniques for maintaining cache coherency in a data processing system.

Data processing systems may include multiple, sometimes relatively large amount of, physical hardware (e.g., processors, memory, storage, I/O, and combinations thereof) to perform different types of workloads (e.g., batch processing, transaction processing, etc.). For example, large data processing systems, such as mainframe computers, may include multiple clusters of processors (e.g., central processing units (CPUs)), memory, and other hardware, where one or more processors in each cluster may have different access pathways to the memory.

In such a multi-hardware data processing environment, the processors may communicate with each other using shared memory. Shared memory systems usually contain a hierarchy of caches where the lowest cache levels are private to each individual processor and the last level cache is shared among all the processors. In such memory systems, it is important to ensure the local caches are in sync, e.g., to prevent processors from processing old data.

One challenge with using shared memory is that the processors within each cluster may or may not contain caches that are coherent with system memory. Consequently, some data processing systems may enforce cache coherency using different types of cache coherence techniques, including, for example, snooping cache coherence techniques and directory-based cache coherence techniques. Snooping cache coherence techniques generally involve broadcasting coherence information to processors over a system bus that handles commands and responses separately from the data movement. For example, the system bus may be used to negotiate for a cache line(s), and then, based on the outcome of that negotiation, the actual cache line(s) are moved on a data sub-bus. Directory-based cache coherence techniques generally involve storing information about the status of a cache line in a directory. For example, the directory entry for a cache line may include information about the state of the cache line in all caches. Thus, in a directory-based cache coherence technique, cache coherence may be maintained by point-to-point messages between the caches, as opposed to broadcast messages. The state of each cache line in snooping cache coherence techniques and directory-based cache coherence techniques may be specified according to a cache coherency protocol, such as MEI, MESI, and MOESI, as illustrative, non-limiting examples. In MESI, in particular, each copy of the each cache line is in one of the following states: “Modified (M),” “Exclusive (E),” “Shared(S)” or “Invalid (I).”

As data processing systems evolve to support an ever increasing amount of physical hardware, some issues of concern typically involve (i) the amount of time that it takes to perform processor-to-processor communication, (ii) the amount of resources (e.g., memory) used to keep track of the cache line states, or (iii) a combination thereof. For example, in large data processing systems, there may be a significant latency experienced by processors when having to communicate with system memory using snooping cache coherence techniques. Additionally, large data processing systems may have to store a significant amount of coherency information in directories with directory-based cache coherence techniques.

### SUMMARY

One embodiment described herein is a computer-implemented method. The computer-implemented method includes receiving a fetch request from a first processor of a plurality of processors in a first cluster. The computer-implemented method also includes performing a local snoop operation for the first cluster, in response to the fetch request. The local snoop operation is performed without involving an upper level cache associated with the first cluster. The computer-implemented method further includes sending a fetch response to the first processor, based on the local snoop operation.

Another embodiment described herein is a system. The system includes a cluster including a plurality of processors. The system also includes an upper level cache coupled to the cluster. The cluster includes logic configured to perform an operation. The operation includes receiving a fetch request from a first processor of the plurality of processors. The operation also includes performing a local snoop operation for the cluster, in response to the fetch request. The local snoop operation is performed without involving the upper level cache. The operation further includes sending a fetch response to the first processor, based on the local snoop operation.

Another embodiment described herein is a computer-implemented method. The computer-implemented method includes receiving a fetch request from a processor of a plurality of processors in a cluster. The computer-implemented method also includes sending a snoop request to trigger a local snoop operation for the cluster, in response to the fetch request. The computer-implemented method further includes receiving a snoop response in response to the snoop request. The snoop response includes an indication that at least one processor in the cluster is in an offline state.

### BRIEF DESCRIPTION OF THE DRAWINGS

FIG. 1 is a block diagram of a computing environment, according to one embodiment.

FIG. 2 illustrates an example system, according to one embodiment.

FIG. 3 illustrates an example local snoop operation for a cluster, according to one embodiment.

FIGS. 4A-4C illustrate an example sequence of a snoop operation involving multiple clusters, according to one embodiment.

FIG. 5 illustrates another example local snoop operation for a cluster, according to one embodiment.

FIG. 6 illustrates an example wormhole store operation for a cluster, according to one embodiment.

FIG. 7 illustrates an example snoop fence operation for a cluster, according to one embodiment.

FIG. 8 is a flowchart of a method for maintaining cache coherency in a data processing system, according to one embodiment.

FIG. 9 is a flowchart of a method for implementing a snoop fence in a data processing system, according to one embodiment.

### DETAILED DESCRIPTION

Embodiments herein describe techniques for maintaining cache coherency in a data processing system (e.g. mainframe) with multiple clusters of processors (e.g., CPUs) that communicate with each other using shared memory. For example, in certain embodiments described herein, the data processing system may offload one or more snoop operations from a higher level cache management agent, such as an L3 cache management agent, to reduce overhead on the higher level cache directory (e.g., L3 cache directory). In certain embodiments, the snoop operations that are offloaded may include processor-to-processor data movement of successful snoop hits within a hierarchy of lower level caches (e.g., L1/L2 caches).

Note, to clearly point out novel features of the present invention, the following discussion omits or only briefly describes conventional features of data processing systems which are apparent to those skilled in the art. It is assumed that those skilled in the art are familiar with the general architecture of processors, and in particular with processors which operate in an in-order dispatch, out-of-order execution, or in-order completion fashion. It may be noted that a numbered element is numbered according to the figure in which the element is introduced, and is referred to by that number throughout succeeding figures. Additionally, as used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as block 160, which includes a coherency fabric manager (CFM) 165 configured to offload certain snoop operations from a higher level cache management agent (e.g., L3 cache management agent). In addition to block 160, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 160, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

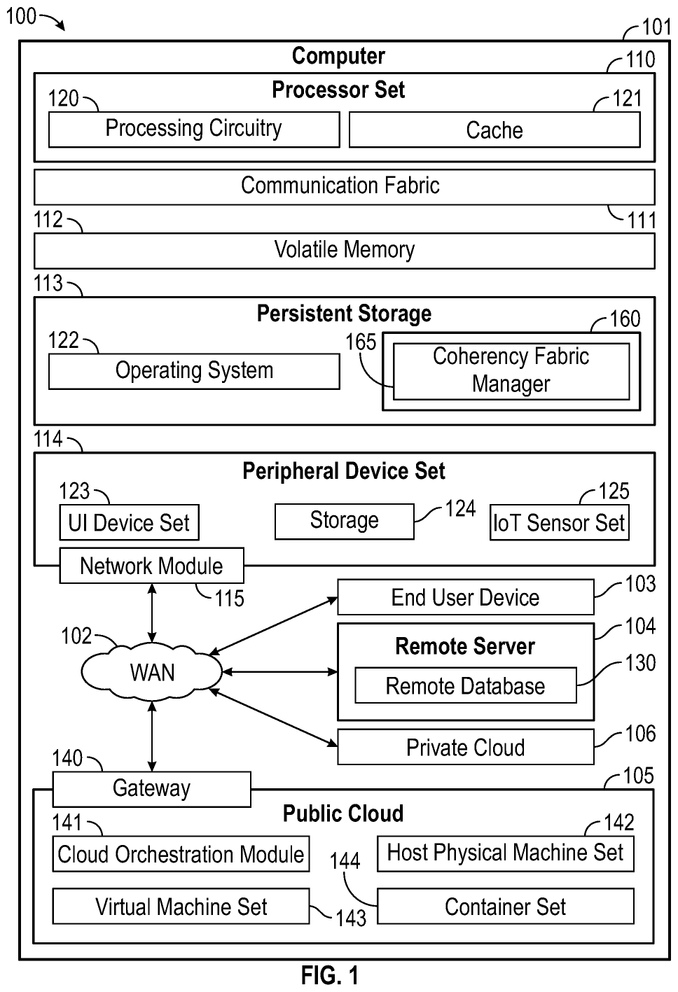

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 160 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 160 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

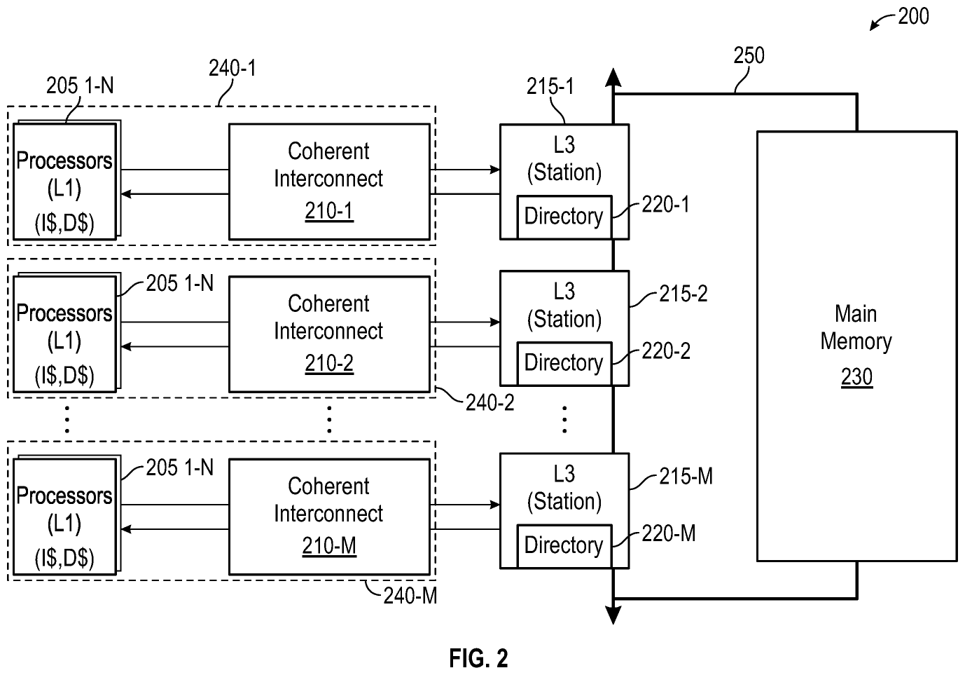

FIG. 2 illustrates an example system 200, according to one embodiment. In certain embodiments, the system 200 is implemented within the computing environment 100 depicted in FIG. 1. The system 200 includes, without limitation, multiple clusters 240 1-M, L3 caches 215 1-M, and main memory 230. The L3 caches 215 1-M are coupled to main memory 230 via a bus (or interconnect) 250. Each L3 cache 215 includes an L3 directory 220, which generally keeps track of which cluster 240 in the system 200 owns which lines of memory. For example, each L3 directory 220 may be an inclusive directory that keeps track of which cluster 240 owns which lines of memory, includes copies of the cache lines, or a combination thereof.

Main memory 230 is generally representative of the main memory storage of the system 200 and may include random access memory (RAM) as well as supplemental levels of memory, such as cache memories, non-volatile or backup memories (e.g., programmable or flash memories), and read-only memories, as illustrative, non-limiting examples. The main memory 230 may include memory storage physically located in the system 200 or on another computing device coupled to the system 200.

Each cluster 240 includes a set of processors 205 1-N and a coherent interconnect 210. In certain embodiments, each coherent interconnect 210 is configured to maintain coherency for the set of processors 205 1-N (within its respective cluster 240) with main memory 230 without the use of a L2 cache (as well as a local L2 directory). That is, each coherent interconnect 210 is configured to keep local caches (e.g. L1 caches, such as instruction (I) cache and data (D) cache) within the set of processors 205 1-N coherent with main memory 230. Each coherent interconnect 210 may include a CFM (e.g., CFM 165) that performs snoop operations for the set of processors 205 1-N within a respective cluster to reduce the overhead on the L3 directory 220.

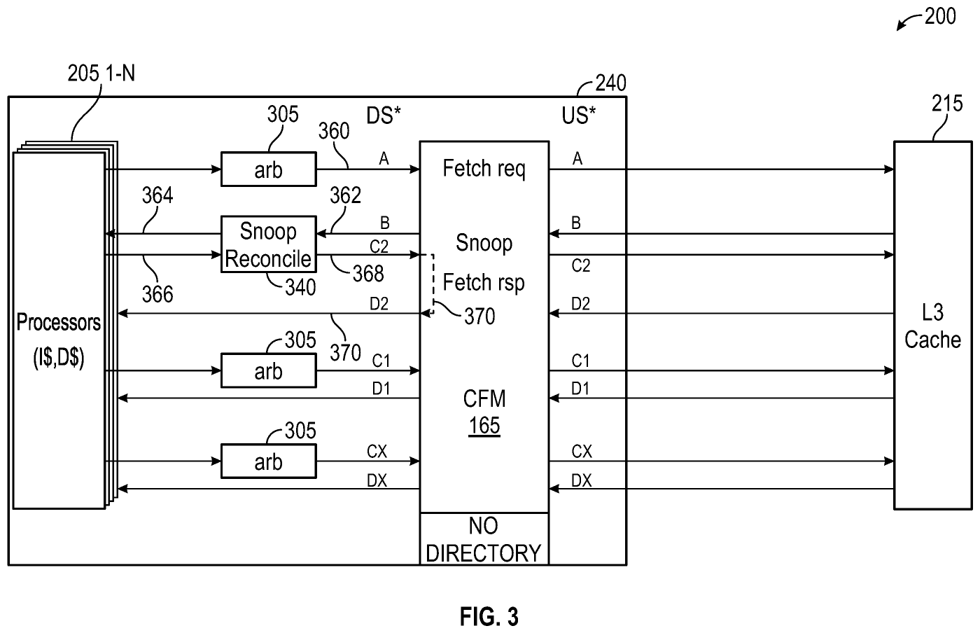

FIG. 3 illustrates an example local snoop operation for a cluster 240, according to one embodiment. In certain embodiments, the cluster 240 includes a CFM 165 configured to perform local snooping for the set of processors 205 1-N within the cluster 240. As shown, the CFM 165 may be implemented without the use of a directory. The CFM 165 may be interconnected with the set of processors 205 1-N via a local downstream (DS*) bus, which may include one or more address buses, command busses, data busses, or a combination thereof. The processors 205 1-N may arbitrate for access to the CFM 165 (e.g., via the DS* bus) via an arbitration component 305. For example, the arbitration component 305 may grant a processor 205 access to the CFM 165 over a common bus (e.g., A bus, C1 bus, . . . , CX bus, etc.) based on an arbitration protocol. Note, the arbitration component 305 may arbitrate across the full set of processors 205 1-N within the cluster 240.

In certain embodiments, the cluster 240 is configured to perform certain snooping operations to reduce overhead on the L3 directory 220. Here, for example, the cluster 240 includes a snoop reconcile component 340, which is configured to send multiple snoop requests to the processors 205 1-N on behalf of the CFM 165, collect multiple snoop responses from the processors 205 1-N on behalf of the CFM 165, and send a single snoop response back to the CFM 165. For example, when the CFM 165 receives a fetch request from a requesting processor 205 (360), the fetch request may trigger the CFM 165 to perform a local snoop of the processors 205 1-N within cluster 240. Note, the snoop reconcile component 340 may be implemented by snoop controller (not shown) within the cluster 240.

As part of the local snoop, the CFM 165 may send a snoop request trigger to the snoop reconcile component 340 (362). Upon receiving the snoop request trigger, the snoop reconcile component 340 may send a snoop request to each processor 205 1-N to determine which, if any, of the processors 205 has the cache line indicated in the fetch request (364). For example, each processor 205, in response to the snoop request, may send a consolidated snoop response back to the snoop reconcile component 340 that indicates whether that processor 205 has the cache line (366). Once the snoop reconcile component 340 receives all the snoop responses, the snoop reconcile component 340 may send a single response to the CFM 165 (e.g., on the C2 bus) indicating whether the cache line has been found (e.g., one of the processors 205 has the cache line) or has not been found (e.g., none of the processors 205 has the cache line) (368).

In certain embodiments, if the CFM 165 determines there has been a snoop hit as a result of the local snoop (e.g., the consolidated snoop response indicates one of the processors 205 has the cache line), then the CFM 165 may move the cache line to the requesting processor (e.g., on the D2 bus) (370), without involving the L3 cache 215. In this manner, the CFM can offload snoop operations away from the L3 cache by relying on information from downstream processors.

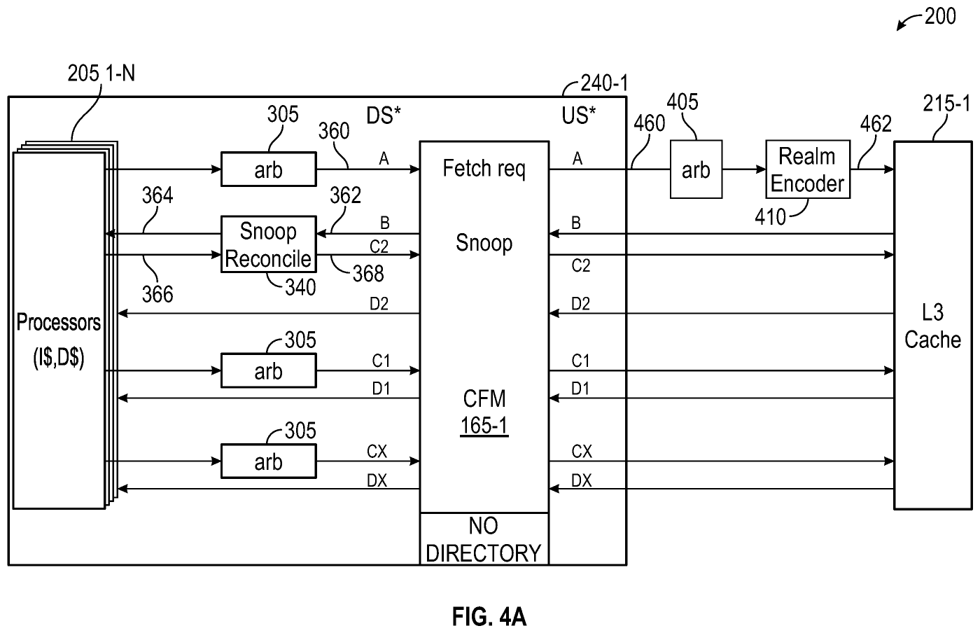

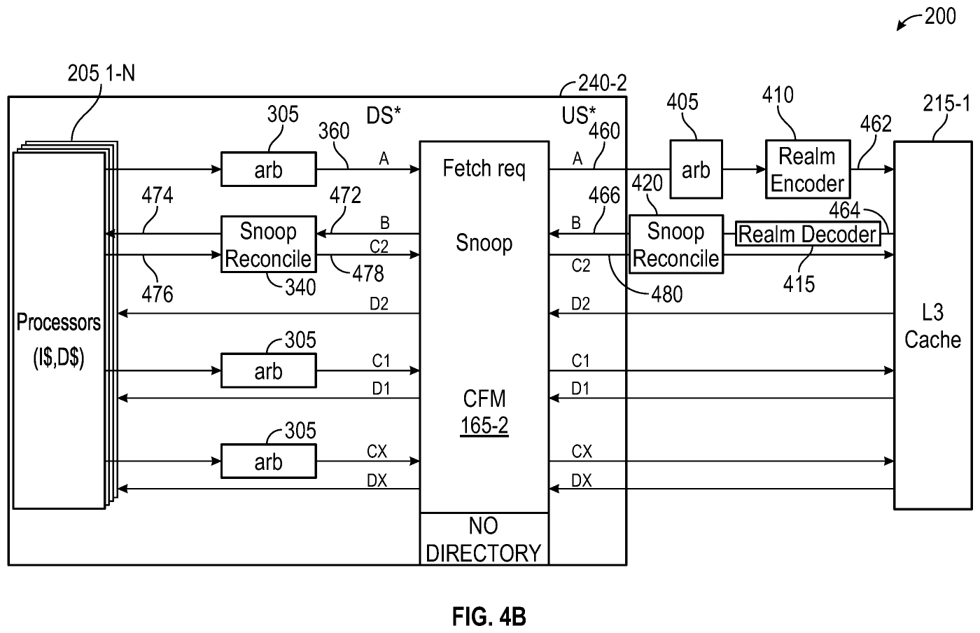

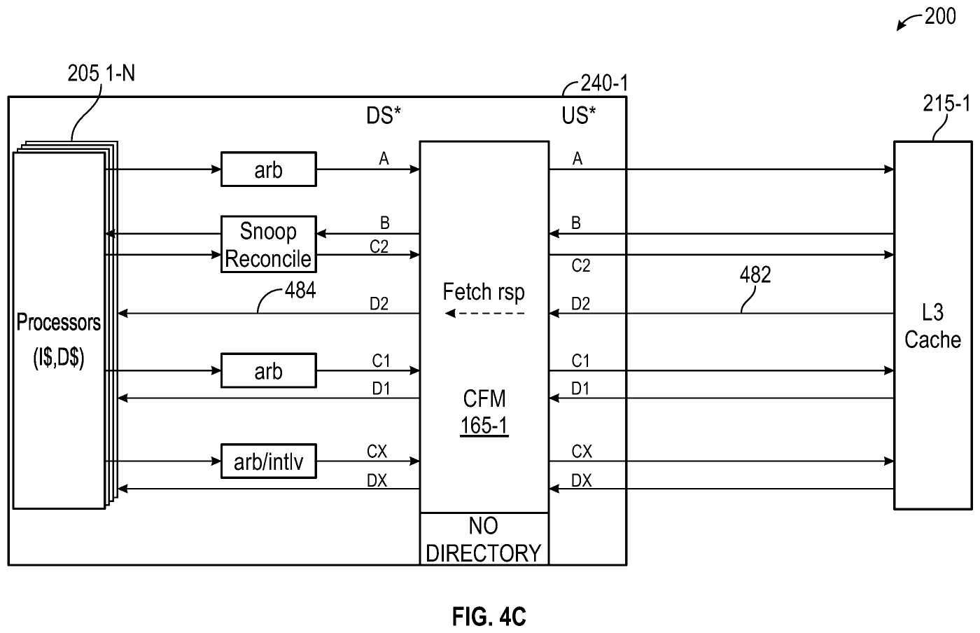

FIGS. 4A-4C illustrate an example sequence of a snoop operation involving multiple clusters 240, according to one embodiment. Note, for the sake of clarity, certain operations described in FIGS. 4A-4C that are similar to the operations described in FIG. 3 may not be described again. Here, in FIG. 4A, the CFM 165-1 within cluster 240-1 may perform local snooping of processors 205 1-N within cluster 240-1 in response to a fetch request from one of the processors 205 (e.g., requesting processor) within cluster 240-1 (e.g., steps 360, 362, 364, 366, 368). If the local snoop operation fails (e.g., the consolidated snoop response at 368 indicates that the cache line has not been found), then the CFM 165-1 may interact with the L3 cache 215-1 in order to find the cache line.

As shown, the CFM 165 may be interconnected with the L3 cache 215-1 via an upstream (U*) bus, which may include one or more address buses, command busses, data busses, or a combination thereof. The CFM 165-1 may arbitrate for access to the L3 cache 215-1 via the arbitration component 405, which may use an arbitration protocol to grant the CFM 165-1 access to the A bus of US*. Note, the arbitration component 405 may arbitrate across all clusters 240 1-N. Here, for example, once CFM 165-1 is granted access to the A bus, the CFM 165-1 forwards the fetch request from the requesting processor of cluster 240-1 to the realm encoder 410 (460). The realm encoder 410 is generally configured to tag the fetch request with a realm identifier (e.g., cluster number) indicating to which cluster 240 the fetch request belongs. The realm encoder 410 may then forward the fetch request (along with the realm identifier) to the L3 cache 215-1 (462). The L3 cache 215-1 may save the realm identifier in its directory 220.

In certain embodiments, because the directory 220 is an inclusive directory, the L3 cache 215-1 may be able to determine which cluster 240 (among clusters 240 1-M) owns the cache line. After determining which cluster 240 owns the cache line, the L3 cache 215-1 may send a snooping request to the CFM 165 for that cluster. As shown in FIG. 4B, for example, the CFM 165-2 for cluster 240-2 sends a snoop request to a snoop reconcile component 420 via a realm decoder 415 (464). The realm decoder 415 is generally configured to direct the snoop request to the target cluster that owns the cache line (indicated in the incoming fetch request). Here, for example, the snoop reconcile component 420 sends the snoop request to the CFM 165-2 for the target cluster 240-2 (466). The CFM 165-2 may then perform a local snooping operation (e.g., steps 472, 474, 476, 478) on processors 205 1-N within cluster 240-2. Note, steps 472, 474, 476, and 478 may be similar to steps 362, 364, 366, and 368, respectively.

As shown in FIG. 4B, upon receiving the consolidated snoop response (478), the CFM 165-2 may forward the consolidated snoop response to the L3 cache 215-1 via the snoop reconcile component 420 (480). The consolidated snoop response received at 480 may include (i) an indication of which processor 205 within the cluster 240-2 includes the cache line, (ii) the cache line, or (iii) a combination thereof. As shown in FIG. 4C, the L3 cache 215-1 may then move the cache line (from the target cluster 240-2) to the CFM 165-1 for cluster 240-1 on the D2 bus (482). The CFM 165-1 may then move the cache line to the requesting processor 205 within cluster 240-1 (484). In this manner, embodiments enable an upstream cache to manage a snoop if a cache line cannot be found in downstream caches.

In certain embodiments, there may be instances in which there are one or more shared cache lines across multiple clusters 240 (e.g., one or more processors in multiple clusters may have a cache line in the shared state). In such embodiments, when the L3 cache 215-1 (e.g., in FIG. 4A) receives a request for a shared cache line (that cannot be resolved within cluster 240-1), the L3 cache 215-1 may (i) determine, from its directory 220, which clusters are sharing the cache line (e.g., the L3 cache 215-1 may record all the clusters (as opposed to processors) that are sharing the line), and (ii) invalidate (e.g., via snoop) all the clusters which are sharing the line. For example, within each target cluster 240, the CFM 165 for that cluster may invalidate (e.g., via snoop) the shared line in any of the processors 205 within that cluster. The snoop reconcile component 340 within each target cluster may generate a consolidated snoop response (for the processors 205 within that target cluster) and send the consolidated snoop response to the snoop reconcile component 420 via the CFM 165 for the target cluster. In one reference example shown in FIG. 4B, assuming cluster 240-2 is one of the target clusters, the CFM 165-2 may invalidate the shared line in any of the processors 205 1-N within cluster 240-2, receive a consolidated snoop response from the snoop reconcile component 340 within cluster 240-2, and forward the consolidated snoop response to the snoop reconcile component 420.

The snoop reconcile component 420 may receive consolidated snoop responses from the respective CFM 165 for each target cluster and may generate and transmit a single snoop response for all the target clusters to the L3 cache 215-1. As shown in FIG. 4C, the L3 cache 215-1 may then send a shared fetch response with the data to the requesting cluster 240-1 and record that cluster in its directory 220.

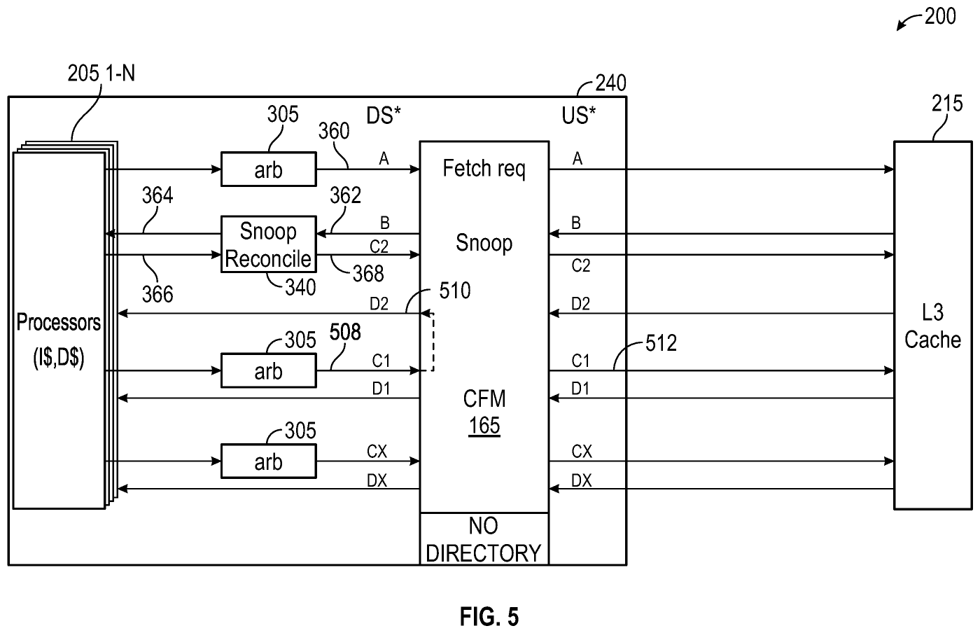

FIG. 5 illustrates another example local snoop operation for a cluster 240, according to one embodiment. Note, for the sake of clarity, certain operations described in FIG. 5 that are similar to the operations described in FIG. 3 may not be described again. In certain instances, a processor 205 within a cluster 240 may voluntarily release the target cache line while a local snoop operation is being performed. In such instances, the CFM 165 can act as a point of coherency if a voluntary release occurs during the snoop.

As shown in FIG. 5, for example, while a local snoop (e.g., steps 362, 364, 366, 368) is being performed to determine which processor 205 has the requested cache line, one of the processors 205 may voluntarily release the requested cache line (508). When a voluntary release occurs, the CFM 165 may capture the cache line (508) (e.g., via C1 bus) and return it to the requesting processor (510) (e.g., via D2 bus). Additionally, in certain embodiments, the CFM 165 may concurrently write back the cache line to upstream cache (e.g., L3 cache 215) (512) (e.g., via C1 bus).

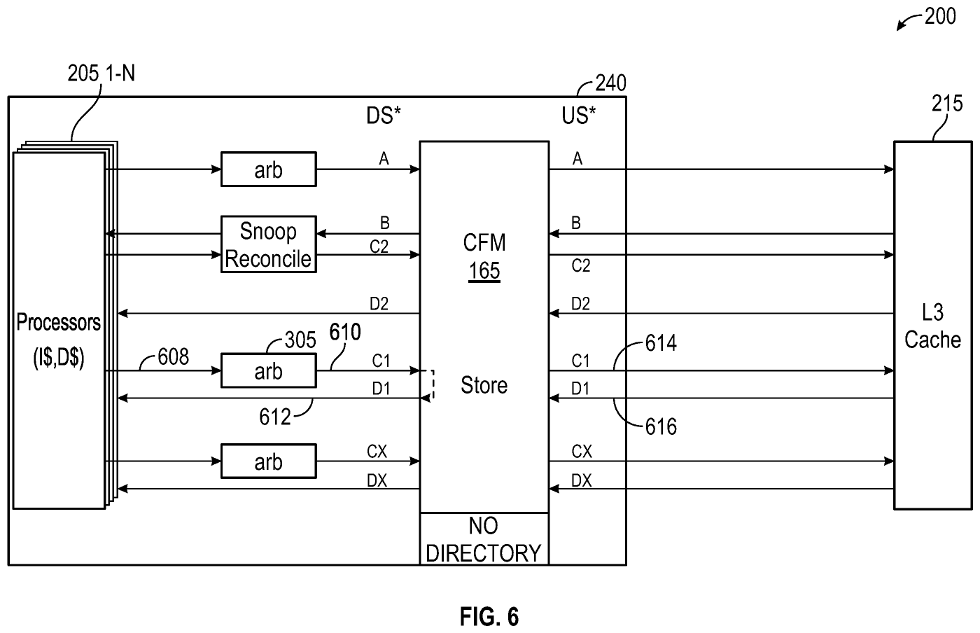

FIG. 6 illustrates an example “wormhole” store operation for a cluster 240, according to one embodiment. In the depicted embodiment, if one of the processors 205 (e.g., requesting storer) needs to evict a cache line, the processor may arbitrate for access to the CFM 165 via the arbitration component 305 (608). The CFM 165 may intercept the store request (610) and give an immediate write response back to the requesting storer (e.g., on the D1 bus) (612). The CFM 165 may then take ownership of the cache line and “own” the cache line while transferring it to the upper level cache (e.g., L3 cache 215) (614 and 616). For example, after the processor sends the store request, the processor can move on to the next line of code (without ownership of the cache line) while the CFM (with ownership of the cache line) pushes the store request to the upper level cache.

In certain embodiments, any requests for the cache line that the CFM 165 receives while it owns the cache line may be handled without the upper level cache's involvement. For example, if another processor requests the cache line while the CFM 165 owns it, the CFM 165 may hold the request until the store is completed so that the CFM 165 can make sure that the requesting processor gets a coherent copy of the cache line.

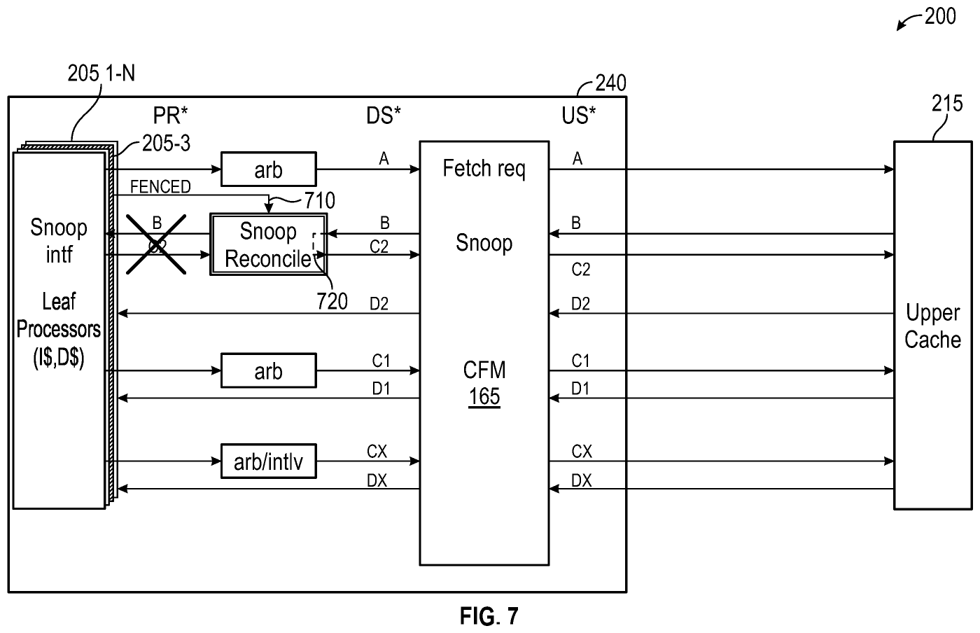

FIG. 7 illustrates an example snoop fence operation for a cluster 240, according to one embodiment. Note, for the sake of clarity, certain operations described in FIG. 7 that are similar to the operations described in FIG. 3 may not be described again. In certain instances, a processor 205 within a cluster 240 may be in an off-line state when a local snoop is being performed. In such instances, the local snoop operation may not be able to complete while the processor is offline.

To address this, certain embodiments described herein may implement a snoop fence to indicate to the CFM 165 that at least one of the processors is in an offline state during a snoop operation. As shown in FIG. 7, for example, the snoop reconcile component 340 may receive an indication 710 of which processor (e.g., processor 205-3) is in an offline state. If a particular processor 205-3 is not be used and the snoop reconcile component 340 receives a snoop request trigger from the CFM 165, the snoop reconcile component 340 may handle the snoop by returning an “invalidated” message back to the CFM 165 on behalf of the “offline” processor 205-3 (720) while maintaining a “no-valid, not ready” status back to the processor 205-3. In certain embodiments, when the processor 205-3 comes online, the snoop reconcile component 340 may remove the “no-valid, not-ready” status and pass the snoop requests to the processor 205-3.

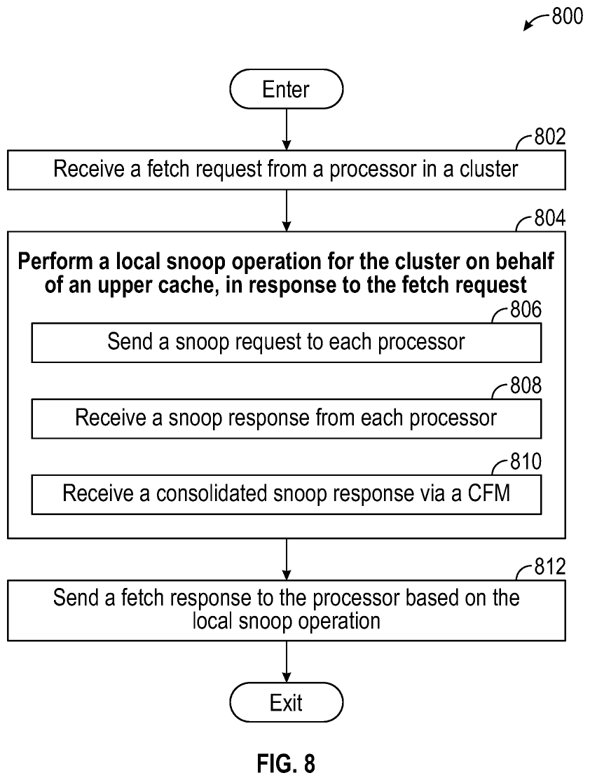

FIG. 8 is a flowchart of a method 800 for maintaining cache coherency in a data processing system, according to one embodiment. The method 800 may be performed by software (e.g., CFM 165, snoop reconcile component 340, etc.).

Method 800 may enter at block 802, where the CFM 165 receives a fetch request from a processor (e.g., processor 205) of multiple processors (e.g., processors 205 1-N) in a cluster (e.g., cluster 240).

At block 804, the CFM 165 performs a local snoop operation for the cluster on behalf of an upper level cache, in response to the fetch request. Block 804 may include (sub)-blocks 806, 808, and 810. At (sub)-block 806, a snoop request is sent to each processor. At (sub)-block 808, a snoop response is received from each processor. At (sub)-block 810, a consolidated snoop response is received by the CFM 165. The consolidated snoop response indicates whether one of the processors has a cache line associated with the fetch request.

At block 812, the CFM 165 send a fetch response to the processor based on the local snoop operation.

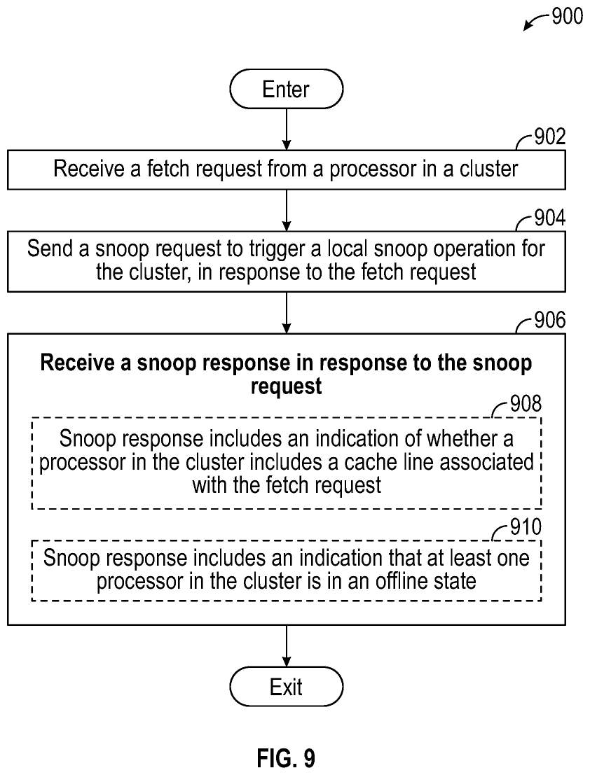

FIG. 9 is a flowchart of a method 900 for implementing a snoop fence in a data processing system, according to one embodiment. The method 900 may be performed by one or more components (e.g., CFM 165, snoop reconcile component 340, etc.) of a data processing system.

Method 900 may enter at block 902, a CFM (e.g., CFM 165) receives a fetch request from a processor (e.g., processor 205) of multiple processors (e.g., processors 205 1-N) in a cluster (e.g., cluster 240).

At block 904, the CFM sends a snoop request to trigger a local snoop operation for the cluster, in response to the fetch request. At block 906, the CFM receives a snoop response in response to the snoop request. In certain embodiments, the snoop request includes an indication of whether a processor in the cluster includes a cache line associated with the fetch request (block 908). In other embodiments, the snoop request includes an indication that at least one processor in the cluster is in an offline state (block 910).

While the foregoing is directed to embodiments of the present invention, other and further embodiments of the invention may be devised without departing from the basic scope thereof, and the scope thereof is determined by the claims that follow.

What is claimed is:

1. A computer-implemented method comprising:
receiving a fetch request from a first processor of a plurality of processors in a first cluster;
performing a local snoop operation for the first cluster, in response to the fetch request, wherein the local snoop operation is performed without involving an upper level cache associated with the first cluster; and
sending a fetch response to the first processor, based on the local snoop operation.

2. The computer-implemented method of claim 1, wherein performing the local snoop operation comprises:
triggering a snoop controller to (i) send a snoop request to each of the plurality of processors in the first cluster and (ii) receive a snoop response from each of the plurality of processors in the first cluster; and
receiving a single consolidated response from the snoop controller indicating whether one of the processors in the first cluster has a cache line associated with the fetch request.

3. The computer-implemented method of claim 2, wherein the fetch response comprises data associated with the cache line when the single consolidated response indicates that one of processors in the first cluster has the cache line.

4. The computer-implemented method of claim 1, further comprising upon determining that the local snoop operation has failed:
forwarding the fetch request to an upper level cache associated with the first cluster; and
tagging the fetch request with an identifier corresponding to the first cluster.

5. The computer-implemented method of claim 1, further comprising:
receiving a snoop request from an upper level cache associated with a second cluster, wherein the snoop request comprises an identifier corresponding to the first cluster;
in response to the snoop request, performing another local snoop operation for the first cluster; and
sending a snoop response to the upper level cache associated with the second cluster, the snoop response comprising (i) an indication of a processor within the first cluster has a cache line associated with the snoop request and (ii) the cache line.

6. The computer-implemented method of claim 5, wherein the identifier corresponding to the first cluster is obtained from a directory within the upper level cache associated with the second cluster.

7. The computer-implemented method of claim 1, wherein the upper level cache is a Level 3 (L3) cache.

8. The computer-implemented method of claim 1, further comprising:
while performing the local snoop operation, detecting that a second processor within the first cluster has released a cache line associated with the fetch request;
in response to the detection, capturing the cache line; and
returning the cache line to the first processor within the first cluster.

9. The computer-implemented method of claim 8, further comprising writing the cache line to the upper level cache.

10. The computer-implemented method of claim 9, wherein the cache line is written to the upper level cache at a same time that the cache line is returned to the first processor.

11. The computer-implemented method of claim 1, further comprising:
receiving, from a second processor of the plurality of processors in the first cluster, a request to store a cache line; and
in response to receiving the request, sending a write response comprising the cache line to the second processor of the plurality of processors in the first cluster.

12. The computer-implemented method of claim 11, further comprising maintaining ownership of the cache line after sending the write response for a period of time.

13. The computer-implemented method of claim 12, wherein the period of time is based on an amount of time it takes to write the cache line to the upper level cache.

14. A system comprising:
a cluster comprising a plurality of processors; and
an upper level cache coupled to the cluster, wherein the cluster further comprises logic configured to perform an operation comprising:
receiving a fetch request from a first processor of the plurality of processors;
performing a local snoop operation for the cluster, in response to the fetch request, wherein the local snoop operation is performed without involving the upper level cache; and
sending a fetch response to the first processor, based on the local snoop operation.

15. The system of claim 14, wherein:
the cluster further comprises a snoop controller; and
performing the local snoop operation comprises:
triggering the snoop controller to (i) send a snoop request to each of the plurality of processors in the cluster and (ii) receive a snoop response from each of the plurality of processors in the cluster; and
receiving a single consolidated response from the snoop controller indicating whether one of the processors in the cluster has a cache line associated with the fetch request.

16. The system of claim 15, wherein the fetch response comprises data associated with the cache line when the single consolidated response indicates that one of processors in the cluster has the cache line.

17. The system of claim 14, wherein the operation further comprises upon determining that the local snoop operation has failed:
forwarding the fetch request to an upper level cache associated with the cluster; and
tagging the fetch request with an identifier corresponding to the cluster.

18. The system of claim 14, wherein the operation further comprises:
while performing the local snoop operation, detecting that a second processor within the cluster has released a cache line associated with the fetch request;
in response to the detection, capturing the cache line; and
returning the cache line to the first processor within the cluster.

19. The system of claim 18, wherein the operation further comprises writing the cache line to the upper level cache.

20. A computer-implemented method comprising:
receiving a fetch request from a processor of a plurality of processors in a cluster;
sending a snoop request to trigger a local snoop operation for the cluster, in response to the fetch request; and
receiving a snoop response in response to the snoop request, wherein the snoop response comprises an indication that at least one processor in the cluster is in an offline state.
